(19) United States
(12) Patent Application Publication
(10) Pub. No.: US 2025/0330770 A1
(43) Pub. Date: Oct. 23, 2025

(54) METHOD FOR OBTAINING A POSITION OF A SOUND SOURCE

(71) Applicant: Nomono AS, Trondheim (NO)

(72) Inventor: Audun SOLVANG, Trondheim (NO)

(21) Appl. No.: 18/870,293

(22) PCT Filed: May 31, 2023
(86) PCT No.: PCT/EP2023/064538

§ 371 Date: Nov. 27, 2024

(30) Foreign Application Priority Data
May 31, 2022 (DK) PA 2022 70280

(51) Int. Cl. H04S 7/00; H04R 3/00; H04R 5/027; H04S 3/00

(52) U.S. Cl. CPC H04S 7/307; H04R 3/005; H04R 5/027; H04S 3/008; H04R 2201/401; H04R 2410/01; H04S 2400/01; H04S 2400/11; H04S 2400/15

(57) ABSTRACT

The invention relates to a method for obtaining a position of a sound source relative to a dedicated reference point. A first and a plurality of second sound signals are recorded which are synchronized in time. The position can be obtained by applying an estimated filter to a correlated signal derived by correlation of the first sound signal with at least one of the plurality of second sound signals in the frequency domain. Two timing values are derived in the at least one filtered and correlated signal exceeding a dedicated threshold in the time domain. Then the distance between the dedicated reference point and the sound source based on the respective obtained first timing value and second timing value.

### CROSS-REFERENCE TO RELATED APPLICATIONS

This application is a National Stage Application of PCT Application No. PCT/EP2023/064538, filed May 31, 2023, and claims priority from Danish patent application DK PA 2022 70280 dated May 31, 2022, the contents of which are hereby incorporated herein in their entireties by reference.

The present invention relates to a method for obtaining a position of a sound source relative to a dedicated reference point. The invention also relates to a computer system and to a non-transitory computer-readable storage medium. The invention relates further to a recording device.

### BACKGROUND

Sound field or spatial audio systems and formats like ambisonics or Dolby Atmos provide encoded sound information associated with a given sound scene. By such an approach one may assign position information to sound sources within a sound scene. These techniques are already known in certain computer games in which a recorded sound is attributed with game object position information, but also in live capturing of events, e.g., capturing a large orchestra or sports event. Consequently, the number of possible applications is huge and ranges from the immersive effect indicated above e.g. by having the impression of taking part in the sports event to virtual or augmented reality experiences.

In many cases recording of sound for such applications is a challenge in itself using spatial audio microphones. While those are useful for capturing live sound field information from a particular point in space, they also have some technical limitations since they are based on beamforming techniques and are generally considered expensive. For example, the sound quality of a person located at a large distance from the microphone may be reduced. In more noisy or reverberant situations, or if more than a single person is talking, identification and isolation of individual sound sources for the purpose of equalizing or other processing techniques are difficult.

In the meantime, audio content creators also realize the need for high quality audio including the usage of spatial audio information, either for improving quality of sound recording or for adding additional sound effects increasing the immersion for the listener. Consequently, there is a need for a less costly solution, which achieves the benefits and advantages of the high-level spatial audio microphones. The solution should preferably work irrespective of the hardware, allowing flexible use in different scenarios.

### SUMMARY OF THE INVENTIONS

The present disclosure with its proposed principles provides a method, computer system but also a recording device to achieve several benefits and advantages mentioned above.

The inventor has found a method that offers a precise determination of a position, both in distance and angle of a sound source relative to a dedicated reference point. The method proposed is largely independent of the hardware used and is scalable to different levels of quality. However, with certain dedicated hardware, the method functionality and resolution are greatly improved. Furthermore, the method allows for off-line processing and real-time processing. As a result, the proposed method can be included in a variety of applications including, but not limited to sound capturing and processing for podcasts, film, live or other events, audio and teleconferencing, virtual reality, video games application and the like.

In an aspect, the inventors propose a method for determining a position of a sound source relative to a dedicated reference point. In this regard, the expression “position” does include the distance from the sound source to the dedicated reference point, an angle based on one or two axes through the reference point or a combination thereof.

The method obtains a first sound signal recorded with a microphone at a sound source or at a position known to the sound source. Likewise, a plurality of second sound signals is recorded at a position in a known relation to the dedicated reference point. This reference point can be, for example, defined by dedicated hardware having a plurality of microphones. The first sound signal and the plurality of second sound signals are synchronized in time.

Usually, it is assumed that the first sound signal is recorded at the proximity of the sound source, meaning that the sound emitted by the sound source is recorded at a higher level than reflections, reverberance and background noise due to the proximity between microphone and sound source, and meaning that the distance is relatively low compared to the distance between the sound source and the dedicated reference point. However, the term “at the sound source” is not to be understood in a very limited sense. Rather, the expression shall include and allow for a certain distance between the actual sound source and a microphone. In other words, the location of the microphone in relation to the actual sound source is well known. Similarly, the plurality of second sound signals is recorded at different locations, for which the distance and angle to the reference point is known. Time synchronization is important for the proposed method in subsequent steps. Such time synchronization can be achieved in some instances by providing a common time base for any sound signal recorded. In some other instances, the recorded sound signals can be used to provide a time base, e.g., by timely correlating a dedicated start signal that is recorded and included in the first and the plurality of second sound signals.

A generalized cross correlation, or a modified cross correlation such as the phase transform, is then calculated, time frame by time frame, between the first sound signal and at least one of the plurality of the second sound signals to obtain at least one generalized cross correlation or phase transform signal for each frame of the recorded sound signal. The length of the frame is generally adjustable and may be adjusted during the estimation, e.g. when there is an indication that the sound source is moving.

The generalized cross correlation or phase transform signal is subsequently used to estimate distance between the sound source and the dedicated reference point. Distance estimation is performed by estimating a time delay between the first sound signal and the at least one of the plurality of the second sound signals using at least one phase transform signal.

The angle between the sound source and the dedicated reference point is estimated by evaluating the time delay between each pair of the plurality of second sound signals with weighted least mean square, whereby the weighted least mean square is dependent on the obtained phase transform signals between the first sound signal and the pair of the plurality of second sound signals.

The calculation of the phase transform is done in some aspects by correlating the first sound signal with the at least one of the plurality of second sound signals in the frequency domain to obtain at least one correlated signal. After that the power spectrum is normalized and the at least one correlated signal is transformed back to the time domain. One may use a discrete Fourier transformation, DFT and an inverse DFT and in some instances in particular a short-time Fourier transformation, STFT and inverse STFT or ISTFT.

In cases where a short-time Fourier transformation STFT is used, the STFT can be performed on the first sound signal and on the at least one of the plurality of second sound signals to obtain a respective spectrum. Then, a cross spectrum on the respective spectrums is obtained and a spectrum mask filter to the obtained cross spectrum applied thereupon. After application, the inverse short-time Fourier transformation, ISTFT is conducted to obtain at least one phase transform signal. The above-mentioned mask filter can be estimated on the signal-to-noise ratio in each frequency bin of the first sound signal. For example, a quantile filter, particularly a median filter can be used for smoothing a power spectrum for each time slice of a power spectrum derived from the first sound signal. The noise is estimated for each time slice in response on a previous time slice. The filter parameter is then set to 1 or 0 depending on whether the signal to noise ratio exceeds a pre-determined threshold or not.

In some other aspects, the filter for acting on the signal-to-noise ratio in each frequency bin of the first sound signal can be estimated by using the residual signal from a denoising process as the noise estimate, wherein the denoising process can be optionally based on machine learning.

In some aspect, one may increase time resolution for improved distance and angular accuracy by interpolation. One approach is to perform an up-sampling of the first sound signal and the at least one of the plurality of second sound signals before correlating them in the digital domain. Another approach would be cubic interpolation. This can be done by up-sampling them prior to the discrete or short-time Fourier transformation, or alternatively transforming them back from the frequency domain to the time domain using a higher sampling frequency for the IDFT and ISTFT, respectively. Consequently, one may, in some instances, transform the frequency domain signal back to the time domain at a higher transformation frequency than the transformation frequency used for the transformation step of the first sound signal and the at least one of the plurality of second sound signals to the digital domain.

In some instances, the respective phase transform signal can be calculated between the first sound signal and each of the plurality of the second sound signals. This will subsequently allow estimating the distance from the sound source to each of the location of the second sound signal enabling further statistics and thereby improving accuracy.

Some further aspects concern the step of estimating a time delay. For this purpose, it is proposed to search for a maximum in the at least one phase transform signal or—alternatively—detect a first magnitude value that is above a given threshold and searching for a maximum within a specified window centered around the first magnitude value. The specified windows may be suitable in case there is a potential crosstalk between different microphones recording various first sound signal, or if the microphone recording the sound signal is located further away from the actual sound source with sound reflections being present.

In other words, the specified window centered around the first magnitude value offers a solution to suppress recorded reflections from the sound signal thereby reducing the risk of estimating the distance or angle with false positive results. The length of the specified window can be set for limit to be inverse proportional to a signal bandwidth estimated from the highest frequency component of the first sound signals. The other limit could be in the range of the expected early reflection depending on the distance between a recording location of the first sound signal and the location of the one or more sound sources. In some instances, the length of the specified window could be proportional to a maximum time of flight between the positions of the plurality of second sound signals.

In some further instances, the dedicated reference point is substantially in the center between the recordal locations of the plurality of second sound signals and wherein the estimation of a distance between the sound source and the dedicated reference point uses a mean value of the set of time delays between the first sound signal and each of the at least one of the plurality of the second sound signals.

Some other aspect concerns the estimation of the angle, including the azimuth angle and elevation angle. The weighted least mean square is dependent on the obtained phase transform signals between the first sound signal and the pair of the plurality of second sound signals if a magnitude value for the obtained phase transform signals is above a given threshold and within a specified window centered around the first magnitude value.

The presently proposed method allows not only to estimate the angle and distance between a sound source and a reference point, but also between two microphones, e.g., two microphones worn at some speakers being spaced apart. Both microphones record the sound signal from the sound source, depicted as first sound signal (recorded at the first microphone) and a further first sound signal (recorded at the location of the second microphone). In such cases, the phase transform may be calculated between a first sound signal and a further first sound signal recorded at or associated with one or more sound sources to obtain a further phase transform signal. Then, the distance between a position of the microphone (recording the first sound signal) and a position associated with the recordal of the further first sound signal can be calculated by estimating a time delay between the first sound signal and the further first sound signal using the further phase transform signal.

This proposed aspect offers a simple tool to calculate the distance between the positions associated with two or more first sound signals. This is useful not only to estimate possible crosstalk between two or more microphones (recording the first sound signals), including classifying sound signals as source signal or cross talk based on the time delay being negative or positive, but also provides information about relative distance between microphones that can be used for post processing making the position estimate. As a result, the approach can be used to obtain information of a sound source, which is distanced from the positions, at which the two (or more) first sound signals are recorded.

Another aspects concerns postprocessing and particular movement of the sound source during processing. In stationary sound sources, the distance may not change during the different frames (apart from possible variation due to the estimation). However, if the sound source is moving slowly, the distance and angle will vary over time. Such sources may be difficult to identify because a moving sound source will influence the STFT by doppler shift. Furthermore, estimation noise can be identified as a moving sound source (or vice versa) of two or more sound sources located at different positions.

To adjust to this observation, one aspect proposes applying a applying a noise reduction filter to the estimated distance and/or the estimated angle. Further or alternatively, a Kalman filter can be applied to the estimated distance and/or the estimated angle and the reduced results thereof, respectively predicting the possible movement. In some instances, such filtering is implemented by applying the gradient or divergence on the estimated distance and/or the estimated angle.

It has been found that certain arrangements of microphones recording the second sound signals may be suitable. Possible reflections or errors can be identified more easily and may cancel each other out. Consequently, the respective positions of a pair of the plurality of second sound signals may be located on a virtual line through the dedicated reference point with the same distance to said dedicated reference point.

It is useful to position the microphones recording the second sound signals at dedicated locations. For example, the plurality of second sound signals may comprise four audio sound signals, wherein two of those four sound signals are recorded with a maximum spatial distance of a few cm. This distance is usually small enough to avoid accidental recordals of direct sound and reflected sound of the same source at the same time, while being large enough to provide enough difference when cross-correlating the second sound signals with the first sound signal without employing excessive up-sampling.

The speed of sound traveling though matter is dependent on the matter temperature. For a precise measurement, the air temperature is measured, particularly in the vicinity of the plurality of second sound sources. Such a measurement can be repeated periodically to compensate for temperature changes during the recordal session. The distance and also the angle can then be estimated in response to the derived air temperature, which changes the speed of sound in the air.

In some further instances, a computer system is provided, comprising one or more processors and a memory. The memory is coupled to the one or more processors and comprises instructions, which when executed by the one or more processors cause the one or more processors to perform the above proposed method and its various steps. Likewise, a non-transitory computer-readable storage medium can be provided comprising computer-executable instructions for performing the Method according to any of the preceding claims.

Another aspect concerns the recording device that comprises a cuboid shape with a bottom surface and a top surface and four side surfaces. The recording device is adapted to be placed with bottom part on any substantially flat surface, like for instance, a floor, as table and the like. The dive may comprise height that is slightly larger than its width or depth. In particular width and depth are similar or equal. The recording device also comprises a user interface accessible on the top surface. The user interface may comprise one or more buttons, a display, switches, and the like provide information to a user and enabling him to interact with the device for its functionality. In this regard, the recording device may include a processor adapted to read user's command and act upon. Furthermore, the processor is configured in some instances to process one or more sound signals at least partially with aspects of the principles proposed herein.

The recording device also comprises a plurality of microphones, in particular omnidirectional microphones, wherein pairs of microphones are arranged on each of the respective side surfaces with a first microphone of the pair of microphones arranged at a top part and a second microphone of the pair of microphones arranged at a bottom part of the respective side surface.

The distance between the first microphone and the second microphone of each pair of microphones is not set to be equal to a distance between first microphones of adjacent side surfaces. In other words, two adjacent microphones are spaced away from each other by the same distance.

In some aspects, a distance from the first microphones to the top surface is larger than a distance from the second microphones to the bottom surface. In some other aspects, the outer dimension of the recording device can be slightly larger than the of two opposite microphones, that is the microphones are slightly displaced and arranged inside the recording device.

### SHORT DESCRIPTION OF THE DRAWINGS

Further aspects and embodiments in accordance with the proposed principle will become apparent in relation to the various embodiments and examples described in detail in connection with the accompanying drawings in which

FIG. 1 illustrates an embodiment of the proposed method showing several process steps for determining the position of a sound source;

FIG. 2 shows the step of a frequency weighted phase transform applying a spectrum mask to obtain a filtered and correlated signal;

FIG. 3A is an illustrative view of a recording environment with several microphones to record a more complex sound field scenario;

FIG. 3B illustrates an embodiment of a sound field microphone implementing some aspects of the proposed principle;

FIG. 4 illustrates a process flow of a method in accordance with some aspects of the proposed principle.

### DETAILED DESCRIPTION

The following embodiments and examples disclose different aspects and their combinations according to the proposed principle. The embodiments and examples are not always to scale. Likewise, different elements can be displayed enlarged or reduced in size to emphasize individual aspects. It goes without saying that the individual aspects of the embodiments and examples shown in the figures can be combined with each other without further ado, without this contradicting the principle according to the invention. Some aspects show a regular structure or form. It should be noted that in practice slight differences and deviations from the ideal form may occur without, however, contradicting the inventive idea.

In addition, the individual figures and aspects are not necessarily shown in the correct size, nor do the proportions between individual elements have to be essentially correct. Some aspects are highlighted by showing them enlarged. However, terms such as “above”, “above” “below”, “below” “larger”, “smaller” and the like are correctly represented with regard to the elements in the figures. So it is possible to deduce such relations between the elements based on the figures.

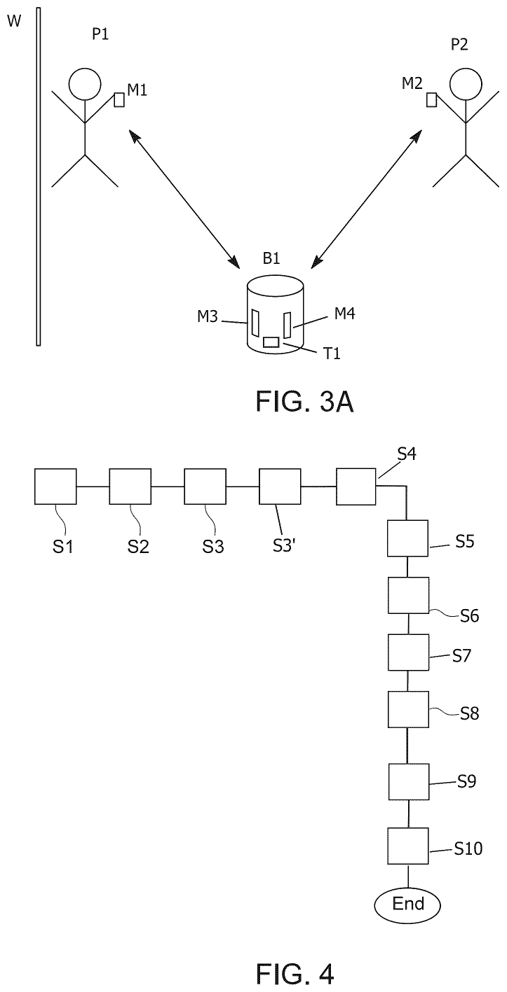

FIG. 3A illustrates an application using the method in accordance with the proposed principle. The scenario corresponds to a typical sound recordals session, in which a plurality of sound signals is recorded to obtain the sound field of a scenery. While the present example uses speech recordals of a natural person, one may realize that the present method and the principles disclosed herein are not limited to speech processing or finding the positions of natural persons. Rather it can be used to localize any dedicated sound source relative to a reference point.

The present scenery contains two sound sources depicted as P1 and P2, which in this embodiment are two respective persons having a conversation in an at least partially enclosed space. Each person holds a microphone M1 and M2, respectively at close proximity to their respective bodies. Alternatively, a microphone M1 and M2 is mounted on their respective chests or at their body. Hence, one can associate the microphones M1 and M2 to be at the positions of the respective sound sources. A plurality of second microphones M3 and M4 is located at position B1. Position B1 is also defined as the reference point. Persons P1 and P2 are therefore located at a certain distance and angle towards reference point B1, and also spaced apart from each other. A wall W is located at one side generating reflections during the speech of each sound sources P1 and P2.

Microphones M1, M2, M3 and M4 are time synchronized with each other, i.e. recording the sound in this scenario is done using a common time base. When recording the conversation, microphone M1 records the speech of person P1 and with some delay also the speech of person P2. Likewise due to the speed of sound and the distance of person P1 from reference point B1, microphones M3 and M4 record the speech of persons P1 and P2 with some delays. Depending on the distance, the delay is different, but in any case, the direct way from the sound source to one of the microphones M3 and M4 is referred to as direct sound.

Assuming now, there is only single sound source P1, one can simply calculate the distance using the direct sound; that is to the reference point B1 using the direct sound; that is by measuring the time delay between the sound signal recorded by microphone M1 and one of microphones M3 or M4 multiplied by the speed of sound.

As the speed of sound is dependent on the temperature, a temperature sensor T1 is located in the proximity of microphones M3 and M4 to measure the air temperature, correcting the effect of temperature changes. The above-mentioned scenario is quite simple and not suitable for real world scenarios. For once, wall W will reflect portions of the speech, which then will be recorded by microphone M1 at relatively low value but also by microphones M3 and M4 after some delay, which could have a relatively high level. Microphone M4 will also record speech. Depending on the scenario, the reflected sound speech superimposes with the ongoing speech. Due to possible constructive interference or other effects, it may occur that the recordal of the indirect reflected sound comprises a higher level than the direct sound. In an even more complex scenario, the second sound source also provides a sound signal at the same time resulting in a superposition of several different sound signals, some of them originating from sound sources P1 and P2, some of them being reflections on the wall.

The present application aims to process the recorded signals in such a way that it is possible to identify and locate the position of the respective sound sources relative to the reference point.

Another application addressing the issue of associating certain position information with a sound source is present in virtual reality (VR) applications. Such application usually includes a 360° stereoscopic video signal with several objects within the virtual environment, some of which are associated with a sound corresponding object.

These objects (both visual and audio) are presented to a user via, for example binocular headphones and stereo headphones, respectively. Binocular headphones are capable of tracking the position and orientation of the user's head (using, for example, IMU/accelerometers) so that the video and audio played to the headphones and earphones, respectively, can be adjusted accordingly to maintain the illusion of virtual reality. For example, at a given moment, only a portion of a 360° video signal is displayed to the user, which corresponds to the user's current field of view in the virtual environment. As the user moves or rotates their head, the portion of the 360° signal displayed to the user changes to reflect how the movement will change the user's view in the virtual world. Similarly, as the user moves, sounds emanating from different locations in the virtual scene may be subjected to adaptive filtering of the left and right headphone channels to simulate frequency-dependent phase and amplitude changes in the sounds that occur in real life due to spatial offset between the ears and the human head and upper body scattering.

Some VR productions consist entirely of computer-generated images and separately pre-recorded or synthesized sounds. However, it is becoming increasingly popular to produce “live action” VR recordings using a camera capable of recording a 360° field of view and several microphones capturing the sound field. The recorded sound from the microphone is then processed with the method according to the proposed principle and aligned with the video signal to produce a VR recording that can be played via headphones and earphones as described above.

Another application addressing the issue of associating certain position information with a sound source is present in next generation audio (NGA) applications. Such application usually includes audio objects with metadata such as position.

These objects (both visual and audio) are presented to a user via, for example head tracked stereo headphones with binaural rendering. Such headphones are, as binocular headsets, capable of tracking the orientation of the user's head (using, for example, IMU/accelerometers) so that the audio played to the headphones, can be adjusted accordingly to maintain the illusion of being immersed by the audio. For example, as the user moves or rotates their head, sounds emanating from different locations in the virtual scene, or recorded scene using this innovation, may be subjected to adaptive filtering of the left and right headphone channels to simulate frequency-dependent phase and amplitude changes in the sounds that occur in real life due to spatial offset between the ears and the human head and upper body scattering.

Referring back to FIG. 3A, the Figure illustrates an embodiment of a sound recording device in accordance with some aspects of the present invention suitable to record a plurality of sound signals to be used for the proposed method. In particular, the sound recording device is an ambisonics microphone, designed for Multiple Input and Multiple Output (MIMO) beamforming targeting directivities that correspond to spherical harmonics basis functions.

The sound recording device is formed as a cuboid, as such shape with the specific dimensions is suitable for recording sound files. In addition, the cubic shape allows for a display and a user interface on top of the recording device, such that it can be placed with its bottom part on a suitable surface and still operated in an easy fashion. A screw on the bottom enables the device to be placed on a stand.

The eight microphones in the sound recording device are arranged in an octahedron configuration, i.e., the center of the octahedron faces. The beamforming (the so called ambisonics B-format conversion) comprises weighted sum, that is dependent on the spherical harmonics basis functions and the microphone configuration, and a set of filters employed on the beamformed signals adapted to the scattering of the recording device in order to achieve a flat frequency response. For wavelengths longer than the physical dimension of the cube the acoustic scattering can be approximated as a hard sphere. Hence, the filters can be adapted and simplified to this approximation at lower frequencies.

The surface of the recording device introduces scattering that comprises an effect that prevents destructive interference when recording a signal with the same wavelength as the device by two microphones on opposite sides.

Consequently, the sound recording device of FIG. 3B includes 8 omnidirectional microphones, whereas four of those microphones 1A, 1B, 1C, 1D are located on the upper portion with one microphone on each side. Likewise, four microphones 2A, 2B, 2C and 2D are arranged on the lower portion with one microphone on each side. No microphones are placed at the bottom or at the top, so that the cuboid can be placed on a surface leaving space for user interface.

The microphone tubes are slightly displaced towards the center, by arranging them in respective recesses. The distance d between two adjacent microphones, e.g., between 1A and 1B or 2A and 2B is equal. In other words, adjacent microphones are located equidistantly towards each other.

The equation

$${f}_{lim} = \frac{c}{2 d}$$

define the upper spatial aliasing frequency limit fₗᵢₘ, according to the Shannon criterion, with the distance d between any pair of adjacent microphones. Above this frequency grating lobes will start to occur in the directivity of the beamformed signals. With longer wavelength than the dimension of the recording device, the acoustical scattering is approximately the same as for a hard sphere. The distance d is set to provide an upper frequency limit of 3 kHz to 4 kHz and allows to approximate the acoustic scattering from the recording device to a sphere up to the spatial aliasing frequency.

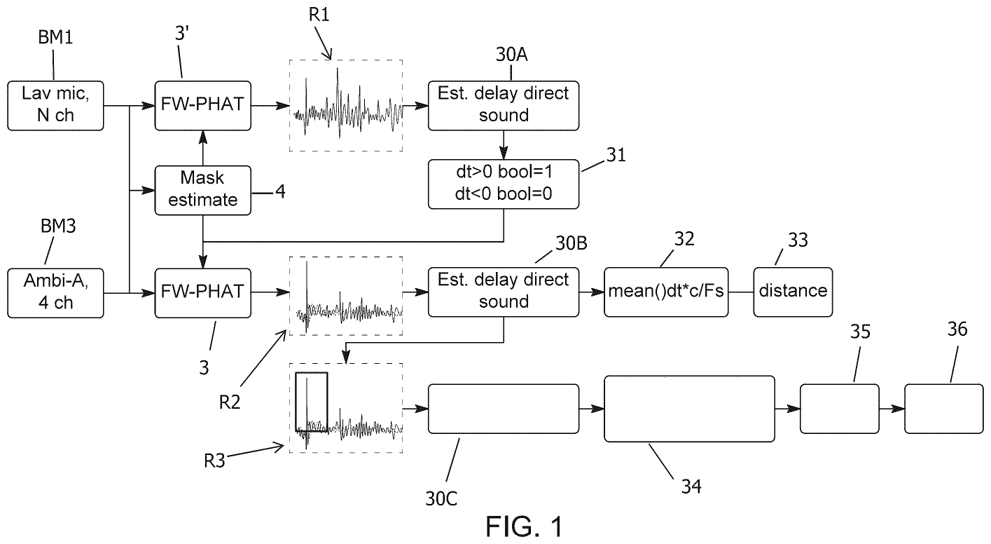

Referring now to FIG. 1 illustrating various blocks of the method in accordance with the proposed principle. For the purpose of simplicity, the method is explained using the above-described scenario of FIG. 3A and FIG. 3B. The method is suitable for postprocessing pre-recorded sound signals but also for real-time sound signals e.g., during an audioconference, a live event, and the like. The method starts with providing one or more first sound signals and a plurality of second sound signals in blocks BM1 and BM2, respectively. The recorded sound signals preferably comprise the same digital resolution including the same sample frequency (e.g., 14 bit at 96 kHz. In case different resolutions or sampling frequencies are used, it is advisable to re-sample the various sound signals to obtain signals with the same resolution and sampling frequency.

The upper portion of the picture including elements 3′, R1, 30A and 31 concerns the identification of possible crosstalk between two or more first sound signals, that is sound signals, which are recorded by microphones, for which the position is to be determined. As mentioned previously, reflections, but also direct sound are recorded by the two microphones in block BM1. To determine which of the two or more microphone is actually positioned at the respective sound source, the signals recorded by the two microphones are to be processed filtered and cross correlated to obtain a time difference in the cross correlation.

For this purpose, both signals are processed using a frequency weighted generalized cross correlation or phase transformation 3′. In a first step, each of the first signals are transformed into the frequency domain to use an STFT to obtain a time-frequency spectrum. A spectrum mask filter is derived from the spectrum by first generating a smooth power spectrum S(l,k), with l being the sound signal from the microphone and k the respective frame of the sound signal. For each frequency bin a first order filter estimates the noise n(l,k) in the current frame based on previous frame. The overall noise n(l,k) is given by

$$n ( l , k ) = ( 1 - α ) log ( S ( l , k ) ) + {( n ( l , k - 1 ) )}^{α}$$

with different α depending on S(l,k)<log(n(l,k−1)). Hence, the filter mask is 1 when the SNR is above a certain threshold and otherwise 0. The results are different filter masks, associated with each of the two first signals. In a next step, the cross spectrum is generated by cross correlating two pairs of the first signals and normalizing the result of the cross correlation. Then, the respective estimated filter is applied to the normalized cross spectrum and an inverse STFT is performed to obtain a filtered and correlated signal, see reference sign R1. In this regard, one should note that for the cross spectrum made R_{xy} one should use the filter Fx (for the signal x) and for the cross spectrum R_{yx} the filter Fy (for signal y). The filtered and correlated signals are then used to estimate the signed time difference or delay of the direct sound in both microphones recording the first sound signals. The sign, i.e. dt>0 or dt<0 depicted in block 31 provides information, which microphone is closer to the actual sound source. Consequently, this microphone (and sound signal) is then associated with the respective sound source and the corresponding filter mask.

The above-mentioned steps can be omitted if the association of sound signals to the respective sound source is defined, e.g. if only one first signal is recorded. Referring back to FIG. 3, the blocks 3, R2 to 35 illustrated in the lower part describe the various steps of estimating the distance to the reference points and the angle. Block BM3 contains a plurality of second sound signals recorded by ono or more second microphones whose location is fixed in regard to the reference point. The second sound signals are recorded by the recording device, whereas for the present embodiments a total number of 8 second sound signals are provided. The location of each of the second microphones is slightly different to be able to obtain the angle later on, but close enough that effects like reflections from the wall and the like can be determined and filtered. With respect to the presently proposed method, not all of the second sound signals need to be fully evaluated to obtain the Position. Rather it has been found that the second sound signals recorded by the four microphones closest to the sound source are sufficient to be fully evaluated. To obtain information thereupon, which of the sound signals are closest, one can use various options.

For one, as all microphones are synchronized in time, one may utilize the second sound signals, estimate the correlation of second sound signals between pairs of opposite microphones to obtain the one which have recorded the sound at the earliest time. As an alternative, one can use blocks 3 and 30B as explained further below to evaluate the arrival of the sound at the respective microphones.

The process now is similar as described with the processing of the two or more first sound signals. However, in block 3, the first sound signals (the one for which distance and angle shall be determined) are now cross correlated with at least one of the 8 second sound signals. Block 3 can be performed with each of the second sound signals to provide overall 8 filtered and cross correlated signals, see reference R2 for an example. Alternatively, as described above, the first sound signal is correlated with those 4 second sound signals that are recorded by microphones closest to the sound source.

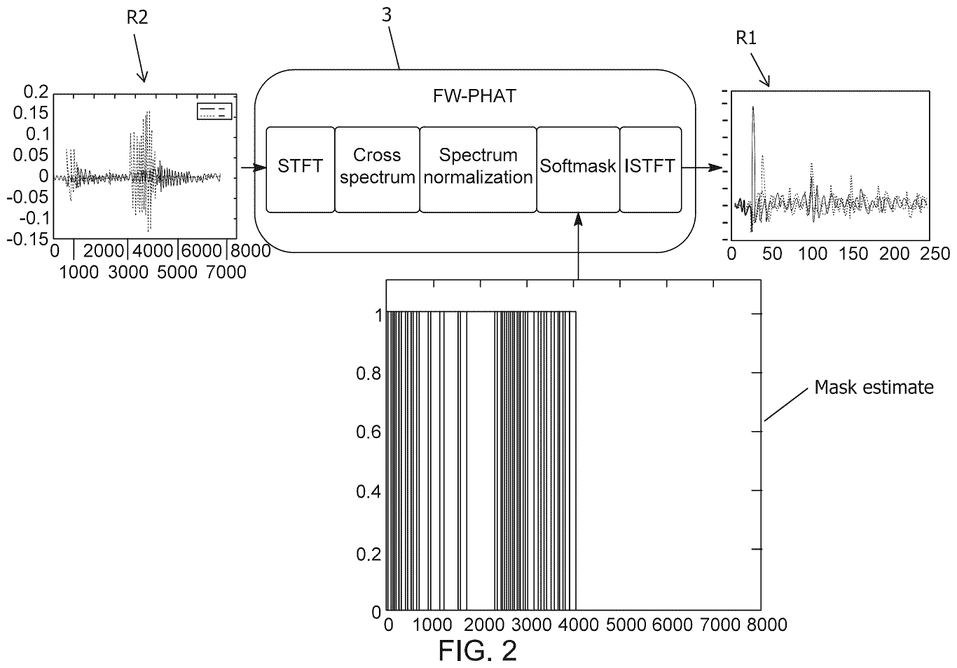

FIG. 2 shows the frequency weighted phase transformation FW-PHAT in an exemplary embodiment. The two input signals are transformed into the frequency domain using an SFTF and then the cross spectrum is derived from it. After normalizing the spectrum, the previously estimated filter, in this case a spectrum mask filter associated with the first sound signal is applied. The result is then transformed back into the time domain using an inverse SFTF.

The time delay in blocks 30B and 30A are estimated by first identifying the maximum value a peak would have if the signals in the frequency weighted PHAT would be uncorrelated. For this purpose, the noise variance is given by sigma=mean(mask)/framesize and the maximum value of the noise derived by sqrt (sigma*2*ln(framesize). Then, a search is performed for the first value in the frequency weighted PHAT that exceeds this maximum (possible including a scale for some headroom) and the search refined for a local maximum close to that first value. The location of the maximum corresponds to the time of flight for the direct sound (n_max/sampling frequency). The distance is then given by the time of flight multiplied by the speed of sound under consideration of the temperature dependency of the speed of sound, assumed to be 20° C. when not measuring ambient temperature. The process in block 30B is repeated for each of the cross-spectrum. The various results are further processed in block 32 by using the mean of the set of time of flights estimates. The distance is then deducted in block 33 from this estimate.

In some aspects, the distance (radius) to a sound source, one may make use of the time difference of arrival between a spot microphone and center of the array, which can be based on the mean value of the set of time difference of arrivals between vectors mᵢ and aₗ, wherein mi is the position of the first microphone recording the first sound signal and aₗ is the location of microphone element l of a total number of L (L=8) in the recording device. The time difference can be obtained from the previous evaluation of the correlated signals. Alternatively, it can be based on a time difference obtained from an evaluation of the sum of the correlated signals.

To obtain the angle between the sound source and the reference points, blocks R3, 30C and 34 to 36 are used. To avoid any influence of room reflections a window function is used to truncate the FW-PHAT results of the first filtered and correlated signal in block R2. The window function, as shown in Figure R2 comprises a width, which is dependent on the distance between the second microphones. As the second microphones recording the second sound signals are spaced apart slightly, the estimated distances between the sound source and the respective second microphone may also vary. The width of the window function for truncating the first filtered and correlated signals is substantially proportional to the maximum of the time of flight between the second microphones.

The now truncated set of filtered and correlated signals can be up sampled to provide a finer time resolution, resulting in a more precise estimate for the angle.

The angle estimation is based on the evaluation of timing differences

$$Δ t {{}_{\vec{{x}_{ι}} \vert \vec{{a}_{k}} , \vec{{a}_{l}}}}_{{}^{}}$$

of sound arrival between two adjacent microphones at location \vec{aₖ}, \vec{aₗ}, due to the sound source located at xᵢ, given by:

$$Δ {t}_{\vec{{x}_{ι}} \vert \vec{{a}_{k}} , \vec{{a}_{l}}} = Δ {t}_{\vec{{m}_{ι}} , \vec{{a}_{k}}} - Δ {t}_{\vec{{m}_{ι}} , \vec{{a}_{l}}}$$

This means that the angle of arrival, both azimuth and elevation can be estimated by trilateration if the source is far away from the array compared to the array baseline (plane wave assumption).

$$Δ {t}_{\vec{{x}_{ι}} \vert \vec{{a}_{k}} , \vec{{a}_{l}}}$$

can be calculated directly from doublets from the set of

$$P {H}_{\vec{{m}_{ι}} , \vec{{a}_{l}}} ( n ) ,$$

l∈{1, . . . , L}. Alternatively, the cross correlation between doublets of PHₘᵢ can be used. When using the cross correlation, the up-sampling of the correlated signals can be replaced with an interpolation, e.g. up-sampling, of the cross correlation for finer time resolution. This interpolation will be carried out on a smaller dataset than up-sampling before the cross correlation making the processing more efficient.

$$Δ {t}_{\vec{{x}_{ι}} \vert \vec{{a}_{k}} , \vec{{a}_{l}}}$$

is proportional to

$$\frac{\vec{{x}_{ι}}}{\vert \vec{{x}_{ι}} \vert} * \frac{\vec{{a}_{l}} - \vec{{a}_{k}}}{c} .$$

Consequently, under a plane wave assumption, the timing difference forms an observation vector

$${T}_{\vec{{x}_{ι}} \vert \vec{a}}$$

for each frame with the components:

$${T}_{\vec{{x}_{ι}} \vert \vec{a}} = [ Δ {t}_{\vec{{x}_{ι}} \vert \vec{{a}_{1}} , \vec{{a}_{2}}} Δ {t}_{\vec{{x}_{ι}} \vert \vec{{a}_{1}} , \vec{{a}_{3}}} Δ {t}_{\vec{{x}_{ι}} \vert \vec{{a}_{1}} , \vec{{a}_{4}}} Δ {t}_{\vec{{x}_{ι}} \vert \vec{{a}_{2}} , \vec{{a}_{3}}} Δ {t}_{\vec{{x}_{ι}} \vert \vec{{a}_{2}} , \vec{{a}_{4}}} Δ {t}_{\vec{{x}_{ι}} \vert \vec{{a}_{3}} , \vec{{a}_{4}}} ]$$

From the matrix, a linear equation can be obtained using the matrix above and the proportional relation resulting in vector A

with A=[\vec{a}₁−\vec{a}₂\vec{a}₁−\vec{a}₃\vec{a}₁−\vec{a}₄\vec{a}₂−\vec{a}₃\vec{a}₂−\vec{a}₄\vec{a}₃−\vec{a}₅]

This array forms a tetrahedral with linearly independent columns. However, also other forms like an octahedron form can be used, as those also provide perpendicular cartesian coordinate axes. This will ultimately provide a proportional relation between

$$\frac{\vec{{x}_{ι}}}{\vert \vec{{x}_{ι}} \vert}$$

and A expressed by

$$\frac{\vec{{x}_{ι}}}{\vert \vec{{x}_{ι}} \vert c} \approx {( {A}^{T} A )}^{- 1} {A}^{T} {T}_{\vec{{x}_{ι}} \vert \vec{a}}$$

The position of the sound source \vec{xᵢ} can be expressed in spherical coordinates [r,θ,ϕ] with

$$\frac{\vec{{x}_{ι}}}{\vert \vec{{x}_{ι}} \vert c} = 1 / c [ - sin {θ}_{i} * cos {ϕ}_{i} , cos {θ}_{i} * cos {ϕ}_{i} , sin {ϕ}_{i} .$$

As the estimates are noisy with different noise variance for each observation,

$$\frac{\vec{{x}_{ι}}}{\vert \vec{{x}_{ι}} \vert c}$$

can be estimated by weighted least mean square:

$$\frac{\vec{{x}_{ι}}}{\vert \vec{{x}_{ι}} \vert c} \approx {( {A}^{T} WA )}^{- 1} {A}^{T} {WT}_{\vec{{x}_{ι}} \vert \vec{a}}$$

With W being a diagonal Matrix having components

$$w {}_{\vec{{x}_{ι}} \vert \vec{{a}_{k}} , \vec{{a}_{l}}} .$$

Each of those components is related to the quality magnitude of the PHAT observation with

$${w}_{\vec{{x}_{ι}} \vert \vec{{a}_{k}} , \vec{{a}_{l}}} = f ( Q {}_{\vec{{x}_{ι}} \vert \vec{{a}_{k}} , \vec{{a}_{l}}} ) .$$

This function can be derived from the cross correlation or the PHAT transform of the microphones aₗ and aₖ, respectively. The quality function can be expressed by:

$${Q}_{\vec{{x}_{ι}} \vert \vec{{a}_{k}} , \vec{{a}_{l}}} = {PH}_{\vec{{m}_{ι}} , \vec{{a}_{l}}} ( Δ {n}_{\vec{{m}_{ι}} , \vec{{a}_{l}}} ) * {PH}_{\vec{{m}_{ι}} , \vec{{a}_{k}}} ( Δ {n}_{\vec{{m}_{ι}} , \vec{{a}_{k}}} )$$

As a result, the

$${w}_{\vec{{x}_{ι}} \vert \vec{{a}_{k}} , \vec{{a}_{l}}}$$

are estimated by

$${w}_{\vec{{x}_{ι}} \vert \vec{{a}_{k}} , \vec{{a}_{l}}} = {Q}_{\vec{{x}_{ι}} \vert \vec{{a}_{k}} , \vec{{a}_{l}}} - \frac{M}{N ( N - 1 )} 2 ln N ,$$

wherein the second term represents the threshold for detecting a time delay during the correlation of the first sound signal with the respective sound signal. M and N are the values giving a ratio M/N that is employed during the PHAT indicating that M out of N frequency bins contain information.

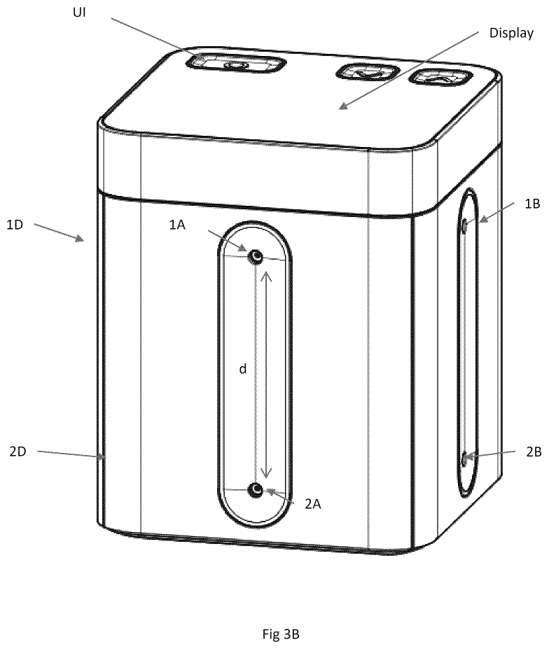

FIG. 4 illustrates the process flow of a method for determining distance and angle in accordance with the proposed principle. The method is suitable for real time processing as well as for off-line processing, in which several previously recorded sound signals forming a sound field are processed.

The method includes in step S1 obtaining a first sound signal recorded at a sound source, for which the distance and angle to a reference point has to be determined. A plurality of second sound signals is recorded either in close proximity of the reference point or at least in a known location or position to the reference point in step S2. First sound signals and the plurality of second sound signals are synchronized in time. Such time synchronization can be achieved by referencing all sound signals against a common time base during the recordal session.

The various signals are then optionally pre-processed in step S3. For example, denoising or equalizing can be performed on the recorded sound signals to improve the results in the subsequent steps of processing. However, care should be taken not to disturb the timing of the signals. It may also be useful in some instances to apply methods during the pre-processing step S3, which preserves phase information of the recorded signal. Further, an STFT is performed on the first sound signal and each of the second sound signals. In step S3′ a correlation between pairs of second sound signals are evaluated, wherein the pair of sound signals correspond to signals recorded by two opposing microphones. The correlation will determine a subset of microphones, at least four, closest to the sound source, as those microphones will record the respective sound signals first. These second sound signals are marked to be used later in step S5.

In the present example, only a single first sound signal associated with a single sound source is present. The first sound signal is processed by estimating a filter in step S4, in particular a spectrum mask filter. The filter acts on the signal to noise ratio in each frequency of the first sound signal in the time domain. The resulting spectrum mask contains a set of “1” and “0” for each frequency bin.

In step S5, the first sound signal is correlated with each of the marked second sound signals of the plurality of second sound signals previously identified in step S3′ in the frequency domain and at least one correlated signal is obtained. The cross correlation can be normalized prior to applying the filter estimated in step S4 to obtain on or more filtered and correlated signals.

Until this point the steps for determining the distance or the angle are similar.

Continuing now with the determination of the distance between the reference point to the sound source and steps S6 to S8. Step S6 includes obtaining a first timing value in the at least one filtered and correlated signal exceeding a dedicated threshold in the time domain. Then, a second timing value corresponding to a threshold value in the at least one filtered and correlated signals based on the first timing value is obtained in step S7. Both steps S6 and S7 may use the previously described search for a maximum value in the PHAT signals (i.e., the filtered and correlated signal). The distance between the dedicated reference point and the sound source is based on the respective obtained first timing value and second timing value in step S8. Still, one may also take the temperature of the air into account. In case of pre-recorded signals, this information is stored and used in S9 to compensate for temperature effects affecting the speed of sound.

Step S9 is executed to derive and estimate the angle of the sound source from the reference point. More precisely, an angle between the sound source and the dedicated reference point can be determined by evaluating the time delay between each pair of the plurality of second sound signals with weighted least mean square. The weighted least mean square is dependent on the obtained phase transform signals between the first sound signal and the subset of second sound signals obtained earlier. For this purpose, Step S9 is executed several times. The angle of arrival, both azimuth and elevation can be estimated by trilateration if the source is far away from the array compared to the array baseline, which is usually the case. The timing difference between the first sound signal and the subset of different second sound signals can be expressed by the correlation results expressed by the PHAT. Alternatively, a cross correlation can be used prior to step S10.

In any case the set of timing differences (indicating the distance between the first microphones and each of the 4 second microphone in the recorder closest to the source) are processed to form an observation vector. The timing difference is somewhat proportional to the distance between two adjacent microphones. Under a plane wave assumption, one can form a vector with 12 components given the 8 microphone recording device presented herein. Hence, any subsets of vectors between microphone pairs in the octahedron form the perpendicular cartesian coordinate axes. A sound source at a certain position is closest to 4 of those microphones.

In step S10, one additional aspect is addressed concerning the processing of sound signals which move over time. For example, if more than one first microphone is present, one may use an active speaker detection algorithm for identifying the current active speaker and the first microphone associated with it. For moving sound signals, one can estimate the location of the und source at different times making use of a dynamic model and Kalman filtering. The Kalman filter keeps track of the estimated state of the system and the variance or uncertainty of the estimate. The estimate is updated using a state transition model and measurements.

1. A method for obtaining a location of a sound source relative to a dedicated reference point, comprising the steps of:
obtaining a first sound signal recorded with a microphone at or associated with one or more sound sources;
obtaining a plurality of second sound signals each recorded at a position in a known relation to the dedicated reference point;
wherein the first sound signal and the plurality of second sound signals are synchronized in time;
for the first sound signal:
calculating a frequency weighted cross correlation between the first sound signal and at least one of the plurality of the second sound signals to obtain at least one frequency weighted cross correlation signal;
estimating a distance between the sound source and the dedicated reference point by estimating a time delay between the first sound signal and the at least one of the plurality of the second sound signals using at least one frequency weighted cross correlation signal; and
estimating an angle between the sound source and the dedicated reference point by evaluating the time delay between each pair of the plurality of second sound signals with weighted least mean square, whereby the weighted least mean square is dependent on the obtained frequency weighted cross correlation signals between the first sound signal and the pair of the plurality of second sound signals.

2. The method of claim 1, wherein calculating a frequency weighted cross correlation comprises the step of:
correlating the first sound signal with the at least one of the plurality of second sound signals in the frequency domain to obtain at least one correlated signal;
modifying the power spectrum by a frequency weighting to obtain at least one frequency weighted correlated signal; and
transforming the at least one correlated signal to the time domain.

3. The method of claim 1, wherein a respective frequency weighted cross correlation signal is calculated between the first sound signal and each of the plurality of the second sound signals.

4. The method of claim 2, wherein the step of transforming the at least one correlated signal to the time domain comprises:
transforming at a higher transformation frequency than a transformation frequency for the transformation step of the first sound signal and the at least one of the plurality of second sound signals to the digital domain.

5. The method of claim 2, wherein the step of correlating the first sound signal comprises the step of:
up-sampling the first sound signal and the at least one of the plurality of second sound signals before correlating them in the digital domain.

6. The method of claim 1, further comprising
calculating a phase transform between a first sound signal and a further first sound signal recorded at or associated with one or more sound sources to obtain a further phase transform signal; and
estimating a distance between a position of the microphone and a position associated with the recordal of the further first sound signal by estimating a time delay between the first sound signal and the further first sound signal using the further phase transform signal.

7. The method of claim 1, wherein the step of calculating a frequency weighted cross correlation, in particular a phase transform comprises the step of:
performing a short-time Fourier transformation, STFT, on the first sound signal and on the at least one of the plurality of second sound signals to obtain a respective spectrum;
obtaining a cross spectrum on the respective spectrograms;
applying a spectrum mask filter to the obtained complex cross spectrum; and
perform a reversed short-time Fourier transformation, ISTFT, to obtain at least one phase transform signal.

8. The method of claim 1, wherein the step of calculating a frequency weighted cross correlation, in particular a phase transform comprises:
estimating a filter acting on the signal-to-noise ratio in each frequency bin of the first sound signal including comprises the steps of:
applying a quantile filter, particularly a median filter for smoothing a power spectrum for each time slice (k) of a power spectrum derived from the one or more first recorded sound signals;
estimating the noise for each time slice (k) in response on a previous time slice; and
evaluating for a given frequency whether the signal to noise ratio exceeds a pre-determined threshold and set the filter parameter for said frequency to 1 or 0 in response thereto.

9. The method of claim 8, wherein estimating a filter acting on the signal-to-noise ratio in each frequency bin of the first sound signal comprises the steps of applying the residual signal from a denoising process as the noise estimate, wherein the denoising process can be optionally based on machine learning.

10. The method of claim 1, wherein the step of estimating a time delay comprises:
searching for a maximum in the at least one frequency weighted cross correlation, in particular a phase transform signal; or
detecting a first magnitude value that is above a given threshold and searching for a maximum within a specified window centered around the first magnitude value.

11. The method of claim 10, wherein the searching for a maximum in the at least one frequency weighted cross correlation, in particular a phase transform signal is dependent on time delay estimates in nearby time frames.

12. The method of claim 10, wherein the window length of the specified window is dependent on at least one of:
inverse proportional to a signal bandwidth estimated from the highest frequency component of the first sound signals;
expected early reflection depending on the distance between a recording location of the first sound signal and the location of the one or more sound sources; or
proportional to a maximum time of flight between the positions of the plurality of second sound signals.

13. The method of claim 1, wherein the dedicated reference point is substantially in the center between the recordal locations of the plurality of second sound signals and wherein the estimating a distance between the sound source and the dedicated reference point comprises the step of one of:
obtaining a mean value of the set of time delays between the first sound signal and each of the at least one of the plurality of the second sound signals, or
obtaining a time delay between the first sound signal and a signal formed by the sum of at least two of the plurality of the second sound signals.

14. The method of claim 1, wherein the weighted least mean square is dependent on one of:
the obtained frequency weighted cross correlation, in particular the phase transform signals between the first sound signal and the pair of the plurality of second sound signals if a magnitude value for the obtained phase transform signals is above a given threshold and within a specified window centered around the first magnitude value; or
the time difference of arrival of the direct sound of the plurality of the frequency weighted cross correlation signals, wherein the plurality of the frequency weighted cross correlation signals is given by the first sound signal and the plurality of second sound signals.

15. The method of claim 1, further comprising:
applying a noise reduction filter to the estimated distance and/or the estimated angle; or
applying a Kalman filter to the estimated distance and/or the estimated angle;
applying the gradient or divergence on the estimated distance and/or the estimated angle.

16. The method of claim 1, wherein the respective positions of a pair of the plurality of second sound signals are located on a virtual line through the dedicated reference point with the same distance to said dedicated reference point.

17. The method of claim 1, wherein the plurality of second sound signals comprises at least four audio sound signals, wherein two of those four sound signals are recorded with a maximum spatial distance of 15 cm.

18. The method of claim 1, further comprising:
obtaining air temperature information, in particular air temperature information in the vicinity of the plurality of second sound sources; and
estimating the distance and/or angle in response to the obtained air temperature information.

19. A computer system comprising:
one or more processors; and
a memory coupled to the one or more processors and comprising instructions, which when executed by the one or more processors cause the one or more processors to perform a method for obtaining a location of a sound source relative to a dedicated reference point, comprising the steps of:
obtaining a first sound signal recorded with a microphone at or associated with one or more sound sources;
obtaining a plurality of second sound signals each recorded at a position in a known relation to the dedicated reference point;
wherein the first sound signal and the plurality of second sound signals are synchronized in time;
for the first sound signal:
calculating a frequency weighted cross correlation between the first sound signal and at least one of the plurality of the second sound signals to obtain at least one frequency weighted cross correlation signal;
estimating a distance between the sound source and the dedicated reference point by estimating a time delay between the first sound signal and the at least one of the plurality of the second sound signals using at least one frequency weighted cross correlation signal; and
estimating an angle between the sound source and the dedicated reference point by evaluating the time delay between each pair of the plurality of second sound signals with weighted least mean square, whereby the weighted least mean square is dependent on the obtained frequency weighted cross correlation signals between the first sound signal and the pair of the plurality of second sound signals.

20. (canceled)

21. A recording device, comprising:
a cuboid shape with a bottom surface and a top surface, and four side surfaces, whereas the recording device is adapted to be placed with bottom part on a surface;
a user interface accessible on the top surface;
a plurality of microphones, in particular omnidirectional microphones, wherein pairs of microphones are arranged on each of the respective side surfaces with a first microphone of the pair of microphones arranged at a top part and a second microphone of the pair of microphones arranged at a bottom part of the respective side surface; and
wherein a distance between the first microphone and the second microphone of each pair of microphones is equal to a distance between first microphones of adjacent side surfaces.

22. The recording device according to claim 20, wherein a distance from the first microphones to the top surface is larger than a distance from the second microphones to the bottom surface.
